(19) United States
(12) Patent Application Publication
(10) Pub. No.: US 2024/0133000 A1
(43) Pub. Date: Apr. 25, 2024

(54) ALUMINUM ALLOY MATERIAL AND ALUMINUM ALLOY OBJECT AND METHOD FOR MANUFACTURING THE SAME

(71) Applicant: INDUSTRIAL TECHNOLOGY RESEARCH INSTITUTE, Hsinchu (TW)

(72) Inventors: Yu-Hsien CHOU, Tainan City (TW); Chi-San CHEN, Kaohsiung City (TW)

(73) Assignee: INDUSTRIAL TECHNOLOGY RESEARCH INSTITUTE, Hsinchu (TW)

(21) Appl. No.: 17/986,962

(22) Filed: Nov. 15, 2022

(30) Foreign Application Priority Data
Oct. 20, 2022 (TW) 111140024

(51) Int. Cl. C22C 21/02; B22D 17/00; B22D 21/00; B22F 1/05

(52) U.S. Cl. CPC C22C 21/02; B22D 17/00; B22D 21/007; B22F 1/05; B22F 10/00; B22F 2301/052

(57) ABSTRACT

An aluminum alloy material includes 1.0 wt % to 13.0 wt % of Si, 0.2 wt % to 1.4 wt % of Fe, 0.2 wt % to 0.8 wt % of Ni, and the remainder being Al and inevitable impurities. The aluminum alloy material can be 3D printed or die-casted to form an aluminum alloy object with a high thermal conductivity.

### CROSS REFERENCE TO RELATED APPLICATIONS

The present application is based on, and claims priority from, Taiwan Application Serial Number 111140024, filed on Oct. 21, 2022, the disclosure of which is hereby incorporated by reference herein in its entirety.

### TECHNICAL FIELD

The technical field relates to an aluminum alloy material, and in particular 1.0 it relates to the aluminum alloy material for 3D printing or die-casting.

### BACKGROUND

Copper has a higher thermal conductivity than aluminum. For example, copper has a thermal conductivity of 390 W/m·K, and aluminum has a thermal conductivity of 238 W/m·K. For this reason, copper is more suitable than aluminum for use as a heat dissipation component in automotive electronic devices. However, copper has poor inherent processability, requiring more processing tools and time. In addition, copper weighs three times as much as aluminum. In the automotive industry, there is an extremely high demand for lightweight materials, and so the weight of copper is a major concern. Conventional aluminum alloy materials such as 6061, 6063, and 1060 aluminum alloys that are suitable for use in heat dissipation components have high thermal conductivity. However, these conventional aluminum alloy materials have low castability and must be shaped by extrusion or cold forging. The aluminum extrusion heat sink was formed in the following steps. The molten aluminum was pressed by high pressure to pass through an extrusion die to generate a continuous and constant section of a green body. This was then processed by a secondary processing procedure to cut the green body into a heat sink. The aluminum extrusion heat sink has a smaller aspect ratio and a simple shape due to process limitations. For example, its heat dissipation effect is lower than that of heat sinks formed using other processes. Cold forging is only suitable for an aluminum alloy with low amounts of additional elements. If there is too high a percentage of additional elements, the cold forging will be difficult. Next, the discontinuous phase of the aluminum ally will interrupt the moldable structure, and this also reduces forgeability. During the cold forging deformation procedure, the material strength is obviously increased, and the pressure that is applied by the material is also increased. As a result of this discontinuous phase, a non-uniform molding flow increases the formation of cracks and pores. Accordingly, there are great restrictions on the use of the above two methods for shaping heat sinks.

The commercial heat dissipation aluminum alloy materials with high forgeability have a large amount of additional elements, and so their heat conductivity is only about 150 W/m·K to 170 W/m·K. After the materials have been processed to shape the heat dissipation components, their thermal conductivity must be dramatically reduced even further.

Accordingly, a novel semiconductor-level aluminum alloy material is called for, wherein the material can be 3D printed and die-casted to form heat dissipation components with high thermal conductivity.

### SUMMARY

One embodiment of the disclosure provides an aluminum alloy material, including: 1.0 wt % to 13.0 wt % of Si; 0.2 wt % to 1.4 wt % of Fe; 0.2 wt % to 0.8 wt % of Ni; and the remainder being Al and inevitable impurities.

In some embodiments, the aluminum alloy material includes: 5.0 wt % to 9.0 wt % of Si; 0.4 wt % to 1.4 wt % of Fe; 0.2 wt % to 0.5 wt % of Ni; and the remainder being Al and inevitable impurities.

One embodiment of the disclosure provides an aluminum alloy object, formed by processing the described aluminum alloy material.

In some embodiments, the aluminum alloy material is in the form of a powder having a diameter of 20 micrometers to 65 micrometers.

In some embodiments, the processing includes 3D printing, die-casting, forging, welding, or milling.

In some embodiments, the aluminum alloy object has a thermal conductivity of 140 W/m·K to 190 W/m·K.

One embodiment of the disclosure provides a method of manufacturing an aluminum alloy object, including processing the described aluminum alloy material to form the aluminum alloy object.

In some embodiments, the aluminum alloy material is in the form of a powder having a diameter of 20 micrometers to 65 micrometers.

In some embodiments, the processing comprises 3D printing, die-casting, forging, welding, or milling.

In some embodiments, the aluminum alloy object has a thermal conductivity of 140 W/m·K to 190 W/m·K.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides an aluminum alloy material, including: 1.0 wt % to 13.0 wt % of Si: 0.2 wt % to 1.4 wt % of Fe; 0.2 wt % to 0.8 wt % of Ni; and the remainder being Al and inevitable impurities. In some embodiments, the aluminum alloy material includes: 5.0 wt % to 9.0 wt % of Si; 0.4 wt % to 1.4 wt % of Fe; 0.2 wt % to 0.5 wt % of Ni; and the remainder being Al and inevitable impurities. If the Si amount is too high, the segregation will be easily occurred to reduce the thermal conductivity of the aluminum alloy object. If the Si amount is too low, the aluminum alloy object will have an insufficient compactness (e.g. having micropores) to reduce the thermal conductivity of the aluminum alloy object. If the Fe amount is too high, sheet or needle-shaped structure of FeAl and Al—Si—Fe will be formed as hard points in the alloy, which may lower the mechanical properties, increase hot cracks, and the object will be brittle. If the Fe amount is too low, the die-casted aluminum alloy object will stick to the mold. If the Ni amount is too high, the thermal conductivity of the aluminum alloy object will be reduced. If the Ni amount is too low, the corrosion resistance of the aluminum alloy material will be reduced. One embodiment of the disclosure provides an aluminum alloy object, formed by processing the described aluminum alloy material. In some embodiments, the processing is 3D printing, and the aluminum powder is in the form of a powder having a diameter of 20 micrometers to 65 micrometers. If the diameter of the powder of the aluminum alloy material is too large, the object shaped by 3D printing will have an overly high surface roughness. If the diameter of the powder of the aluminum alloy material is too small, the powder will be easily aggregated, the uniformity of the powder layer during 3D printing will be degraded, and the compactness of the object shaped by 3D printing will be non-uniform.

In some embodiments, the processing includes 3D printing, die-casting, forging, welding, or milling. In practice, the powder of the aluminum alloy material can be 3D printed to form an aluminum alloy object such as a heat dissipation component (e.g. fins of high aspect ratio, enclosed bending tube having complex figuration, or tubular structures tangled to each other). On the other hand, the aluminum alloy material can be processed by die-casting, forging, welding, or milling to form the aluminum alloy object. When the geometry shape of the object is simple, the aluminum alloy material can be processed by the processing of lower cost to save the manufacture cost. In some embodiments, the aluminum alloy object has a thermal conductivity of 140 W/m·K to 190 W/m·K.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity.

### EXAMPLES

### Comparative Example 1

The aluminum alloy DMS-1 (commercially available from TA CHENG ALUMINIUM CO., LTD.) was heated to 730±10° C. to form an aluminum alloy liquid, which had 0.387 wt % of Si, 1.02 wt % of Fe, 0.012 wt % of Cu, 0.0061 wt % of Mn, 0.042 wt % of Cr, 0.45 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object had many pores inside. The aluminum alloy object had a thermal conductivity of 128.5 W/m·K.

### Comparative Example 2

The aluminum alloy HT-1 (commercially available from TA CHENG ALUMINIUM CO., LTD.) was heated to 730±10° C. to form an aluminum alloy liquid, which had 12.75 wt % of Si, 1.98 wt % of Fe, <0.1 wt % of Cu, <0.02 wt %, of Cr, 0.15 wt % of Ni, <0.001 wt % of Mn, <0.001 wt % of Ti, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.4%) without any obvious defects, but some primary silicon segregation was occurred. The aluminum alloy object had a thermal conductivity of about 141 W/m·K.

### Example 1

The aluminum alloy A1 was heated to 730±10° C. to form an aluminum alloy liquid, which had 1 wt % of Si, 0.6 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 96.2%) without any obvious defects. The aluminum alloy object had a thermal conductivity of about 142.6 W/m·K.

The aluminum alloy A2 was heated to 730±10° C. to form an aluminum alloy liquid, which had 3 wt % of Si, 0.6 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 98.2%) without any obvious defects. The aluminum alloy object had a thermal conductivity of about 147.5 W/m·K.

The aluminum alloy A3 was heated to 730±10° C. to form an aluminum alloy liquid, which had 5 wt % of Si, 0.6 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 98.9%) without any obvious defects. The aluminum alloy object had a thermal conductivity of about 171.4 W/m·K.

The aluminum alloy A4 was heated to 730±10° C. to form an aluminum alloy liquid, which had 7 wt % of Si, 0.6 wt % in of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.5%) without any obvious defects. The aluminum alloy object had a thermal conductivity of about 188.4 W/m·K.

The aluminum alloy A5 was heated to 730±10° C. to form an aluminum alloy liquid, which had 9 wt % of Si, 0.6 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.7%) without any obvious defects. The aluminum alloy object had a thermal conductivity of about 182.3 W/m·K.

The aluminum alloy A6 was heated to 730±10° C. to form an aluminum alloy liquid, which had 11 wt % of Si, 0.6 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.7%) without any obvious defects. The aluminum alloy object had a thermal conductivity of about 165.8 W/m·K.

The aluminum alloy A7 was heated to 730±10° C. to form an aluminum alloy liquid, which had 13 wt % of Si, 0.6 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.7%) without any obvious defects. The aluminum alloy object had a thermal conductivity of about 162.8 W/m·K.

### Example 2

The aluminum alloy B1 was heated to 730±10° C. to form an aluminum alloy liquid, which had 7 wt % of Si, 0.4 wt % in of Fe, 0.2 wt % of Ni. and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.60%) without any obvious defects. The aluminum alloy object had a thermal conductivity of about 181.3 W/m·K.

The aluminum alloy B2 was heated to 730±10° C. to form an aluminum alloy liquid, which had 7 wt % of Si, 0.4 wt % of Fe, 0.5 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.1%) without any obvious defects. The aluminum alloy object had a thermal conductivity of about 170.2 W/m·K.

The aluminum alloy B3 was heated to 730±10° C. to form an aluminum alloy liquid, which had 7 wt % of Si, 0.4 wt % of Fe, 0.8 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.6%) without any obvious defects. The aluminum alloy object had a thermal conductivity of about 161.6 W/m·K.

The aluminum alloy B4 was heated to 730±10° C. to form an aluminum alloy liquid, which had 7 wt % of Si, 0.8 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.5%) without any obvious defects. The aluminum alloy object had a thermal conductivity of about 185.9 W/m·K.

The aluminum alloy B5 was heated to 730±10° C. to form an aluminum alloy liquid, which had 7 wt % of Si, 0.8 wt % of Fe, 0.5 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.7%) without any obvious defects. The aluminum alloy object had a thermal conductivity of about 164.4 W/m·K.

The aluminum alloy 86 was heated to 730±10° C. to form an aluminum alloy liquid, which had 7 wt % of Si, 0.8 wt % of Fe, 0.8 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.4%) without any obvious defects. The aluminum alloy object had a thermal conductivity of about 157.9 W/m·K.

The aluminum alloy B7 was heated to 730±10° C. to form an aluminum alloy liquid, which had 7 wt % of Si, 1.2 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.6%) without any obvious defects. The aluminum alloy object had a thermal conductivity of about 179.3 W/m·K.

The aluminum alloy B8 was heated to 730±10° C. to form an aluminum alloy liquid, which had 7 wt % of Si, 1.2 wt % of Fe, 0.5 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.4%) without any obvious defects. The aluminum alloy object had a thermal conductivity of about 149.9 W/m·K.

The aluminum alloy B9 was heated to 730±10° C. to form an aluminum alloy liquid, which had 7 wt % of Si, 1.2 wt % of Fe, 0.8 wt %, of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.2%) without any obvious defects. The aluminum alloy object had a thermal conductivity of about 143.4 W/m·K.

### Example 3

The aluminum alloy C1 was heated to 730±10° C. to form an aluminum alloy liquid, which had 7 wt % of Si, 0.2 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.6%) without any obvious defects. The aluminum alloy object had a thermal conductivity of about 189.4 W/m·K. However, the aluminum alloy object was difficult to be demolded.

The aluminum alloy C2 was heated to 730±10° C. to form an aluminum alloy liquid, which had 7 wt % of Si, 0.4 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.6%) without any obvious defects. The aluminum alloy object had a thermal conductivity of about 181.3 W/m·K. The aluminum alloy object could be easily demolded.

The aluminum alloy C3 was heated to 730±10° C. to form an aluminum alloy liquid, which had 7 wt % of Si, 0.6 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.4%) without any obvious defects. The aluminum alloy object had a thermal conductivity of about 188.4 W/m·K. The aluminum alloy object could be easily demolded.

The aluminum alloy C4 was heated to 730±10° C. to form an aluminum alloy liquid, which had 7 wt % of Si, 0.8 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.5%) without any obvious defects. The aluminum alloy object had a thermal conductivity of about 185.9 W/m·K. The aluminum alloy object could be easily demolded.

The aluminum alloy C5 was heated to 730±10° C. to form an aluminum alloy liquid, which had 7 wt % of Si, 1.0 wt % of Fe, 0.2 wt % of Ni, and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.6%) without any obvious defects. The aluminum alloy object had a thermal conductivity of about 181.6 W/m·K. The aluminum alloy object could be easily demolded.

The aluminum alloy C6 was heated to 730±10° C. to form an aluminum alloy liquid, which had 7 wt % of Si, 1.2 wt % of Fe, 0.2 wt % of Ni. and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.2%) without any obvious defects. The aluminum alloy object had a thermal conductivity of about 179.3 W/m·K. The aluminum alloy object could be easily demolded.

The aluminum alloy C7 was heated to 730±10° C. to form an aluminum alloy liquid, which had 7 wt % of Si, 1.4 wt % of Fe, 0.2 wt % of Ni. and the remainder being Al and inevitable impurities. The aluminum alloy liquid was put into a die-casting machine and was continuously pressed at a pressure of 120 MPa for 5 seconds to form an aluminum alloy object. As shown in the metallographic phase graph of the aluminum alloy object, the aluminum alloy object was compact inside (e.g. compactness of 99.6%) without any obvious defects. The aluminum alloy object had a thermal conductivity of about 173.4 W/m·K. The aluminum alloy object could be easily demolded.

### Example 4

The aluminum alloy C3 was heated to 730±10° C. to form an aluminum alloy liquid, which had 7 wt % of Si, 0.6 wt % of Fe, 0.2 wt % of Ni, and the remainder being Al and inevitable impurities. The aluminum alloy liquid was put into a die-casting machine and was continuously pressed at a pressure of 120 MPa for 5 seconds to form heat dissipation fins with high aspect ratio. As shown in the metallographic phase graph of the heat dissipation fins with high aspect ratio, the heat dissipation fins with high aspect ratio was compact inside without any obvious defects.

### Example 5

The aluminum alloy material C3 was heated to 770° C. and pressured to about 22 bar for being atomized, and then sprayed and cooled at a flow rate of about 4.5 m³/min to form a powder of the aluminum alloy material with a consistent composition, which had 7 wt % of Si, 0.6 wt % of Fe, 0.2 wt % of Ni, and the remainder being Al and inevitable impurities. The powder of the aluminum alloy material can be 3D printed to form heat dissipation fins with high aspect ratio by a 3D printing equipment of metal powder bed type (AMP-160, commercially available from Tongtai Machine & Tool Co., Ltd.), in which the scan rate was 1200 mm/second, the scan power was 350 W, each of the aluminum alloy powder layer had a thickness of 30 micrometers, and the hatch spacing was 50 micrometers. As shown in the metallographic phase graph of the heat dissipation fins with high aspect ratio, the heat dissipation fins with high aspect ratio was compact inside without any obvious defects.

It will be apparent to those skilled in the art that various modifications and variations can be made to the disclosed methods and materials. It is intended that the specification and examples be considered as exemplary only, with the true scope of the disclosure being indicated by the following claims and their equivalents.

1. (canceled)

2. An aluminum alloy material, comprising:
5.0 wt % to 9.0 wt % of Si;
0.6 wt % to 1.4 wt % of Fe;
0.2 wt % of Ni; and
the remainder being Al and inevitable impurities.

3. An aluminum alloy object, formed by processing the aluminum alloy material as claimed in claim 2.

4. The aluminum alloy object as claimed in claim 3, wherein the aluminum alloy material is in the form of a powder having a diameter of 20 micrometers to 65 micrometers.

5. The aluminum alloy object as claimed in claim 3, wherein the processing comprises 3D printing, die-casting, forging, welding, or milling.

6. The aluminum alloy object as claimed in claim 3, wherein the aluminum alloy object has a thermal conductivity of 140 W/m·K to 190 W/m·K.

7. A method of manufacturing an aluminum alloy object, comprising:
processing the aluminum alloy material as claimed in claim 2 to form the aluminum alloy object.

8. The method as claimed in claim 7, wherein the aluminum alloy material is in the form of a powder having a diameter of 20 micrometers to 65 micrometers.

9. The method as claimed in claim 7, wherein the processing comprises 3D printing, die-casting, forging, welding, or milling.

10. The method as claimed in claim 7, wherein the aluminum alloy object has a thermal conductivity of 140 W/m·K to 190 W/m·K.
